(19) United States
(12) Patent Application Publication
(10) Pub. No.: US 2024/0402351 A1
(43) Pub. Date: Dec. 5, 2024

(54) METHOD FOR DETECTING REPLICAS OF SATELLITE SIGNALS IN A GNSS RECEIVER, CORRESPONDING RECEIVER APPARATUS AND COMPUTER PROGRAM PRODUCT

(71) Applicant: STMicroelectronics International N.V., Geneva (CH)

(72) Inventors: Fabio PISONI, Busto Garolfo (IT); Domenico DI GRAZIA, Cesa (IT); Giovanni GOGLIETTINO, Napoli (IT)

(73) Assignee: STMicroelectronics International N.V., Geneva (CH)

(21) Appl. No.: 18/670,493

(22) Filed: May 21, 2024

(30) Foreign Application Priority Data
May 31, 2023 (IT) 102023000011043

(51) Int. Cl. G01S 19/21; G01S 19/22; G01S 19/30; G06N 3/0464

(52) U.S. Cl. CPC G01S 19/215; G01S 19/22; G01S 19/30; G06N 3/0464

(57) ABSTRACT

A method detects replicas of satellite signals in a GNSS receiver. The satellite signals are transmitted from a plurality of satellites of a constellation of satellites. The method includes navigation processing procedure performed at the GNSS receiver. The method includes receiving at least one of the satellite signals, and for the at least one of the received satellite signals. The method includes dumping in-phase and quadrature components from a correlation procedure of a tracking process of the satellite signals, generating a plurality of delayed signals including the in-phase and quadrature components, and generating a coherently accumulated signal from the delayed signals. The method includes transforming the coherently accumulated signal to a frequency domain signal, generating a bi-dimensional map from the frequency domain signal, and determining whether or not the satellite signals are affected by replicas based on analysis of the bi-dimensional map.

### BACKGROUND

### Technical Field

Embodiments of the present disclosure relate to GNSS receivers.

The present disclosure refers in particular to techniques for detecting replicas of satellite signals in a GNSS receiver, for instance, replicas of the satellite signals due to multipath and/or spoofing attacks.

### Description of the Related Art

In several applications and user cases (automotive, consumer fields) a Position Sensor (PS) is utilized. It is an electronic device composed by a GNSS receiver and a processor aiming to provide accurate position information to user application.

In order to calculate a user position, the processor combines the distance measurements (also known as pseudo-ranges) between user and all the satellites in view measured by the GNSS receiver following a process called triangulation. Final position accuracy reflects the quality of such measurements, that may be affected by several error factors such as multipath and/or spoofing.

Both multipath and spoofing are interferences, generated by different sources, that affect the resulting final position estimated by a GNSS receiver.

Multipath may be a major error source for global navigation satellite systems (GNSS) receivers and may be generated by a satellite signal being reflected by reflecting surfaces or obstacles close to a GNSS receiver antenna.

Such GNSS receiver antenna receives both the satellite signal and replicas of such satellite signal generated by such reflections, and such received replicas, i.e., interferences, may be the cause of alterations in the final position estimated by the GNSS receiver. Such alterations in the estimated position may range from a few meters up to hundreds of meters for highly reflecting obstacles.

Specifically, multipath refers to the combination of Line-of-Sight (LOS) components, i.e., the satellite signal, with a number of Non-Line-of-Sight (NLOS) components, i.e., replicas of the satellite signal caused by the reflection of such satellite signal on nearby obstacles and reflecting surfaces one or more times before reaching the GNSS receiver antenna.

For these reasons, multipath may affect more positions estimated by GNSS receivers in urban environments, where reflections caused by buildings, trees, bridges, or other obstacles may occur more frequently.

Therefore, it is desirable to reduce the effects of multipath interferences to increase the accuracy and robustness of the estimated position, especially in urban environments.

Spoofing is instead an “intelligent” interference generated by a malicious user, i.e., a spoofer, that rebroadcasts a counterfeit signal that is a replica of an authentic satellite signal, for instance, a fake GNSS signal structured to resemble a satellite signal or a satellite signal captured elsewhere and/or at a different time. Such replica may induce a target GNSS receiver to estimate a false and unreliable receiver position, i.e., a fake position determined by the spoofer.

Therefore, it is desirable to detect spoofing attempts to determine the reliability of the position estimated by a GNSS receiver and to take possible countermeasures.

In addition, both multipath and spoofing may be affected by the Doppler effect if the scenario is dynamic, thus, affecting the resulting final position estimated by a GNSS receiver with an additional error component.

Both multipath and spoofing interferences may be detected with known detection methods having the disadvantage of evaluating the resulting GNSS receiver position with inadequate accuracy and robustness to such interferences, especially in urban environments where the position may be wrong by over hundreds of meters.

An example of a known method for detecting multipath interferences may be a multi-correlation technique using code-loop discriminator in double-delta tap configuration, i.e., a multipath detection technique based on 5 correlation taps discriminators (double-delta) and on a continuous comparison between two code discriminators with different multipath sensitivity, for instance, a double-delta code discriminator and an early-minus-late code discriminator.

An example of a known method for detecting spoofing interferences may be based on the combination of channels signals quality metrics, using multiple tracking channels to implement monitor channels in the code delay domain with an increased number of correlators, for instance, 10 correlator taps per monitor channel.

A more accurate method for the estimation of a GNSS receiver position may be found in patent application WO 2021/186194 A1 that discloses a super-correlation method to mitigate spoofing and multipath effects by determining the angles at which satellite signals should arrive at the receiver.

Such a super-correlation method includes a plurality of both computationally and resource demanding complex steps, such as:
receiving signal data from one or more remote sources;
measuring or assuming a movement of the receiver;
determining a first direction, wherein signals received at the receiver along the first direction are desired to be enhanced;
determining a second direction, wherein signals received at the receiver along the second direction are desired to be suppressed;
obtaining first and second phasor sequences indicative of the measured or assumed movement of the receiver in the first and second directions respectively, the first and second phasor sequences each include one or more phasors which include an amplitude and/or an angle;
generating a third phasor sequence based on a weighted combination of the first and second phasor sequences in accordance with the determined first and second directions;
providing a local signal; and
providing a correlation signal using the third phasor sequence, wherein providing the correlation signal includes correlating the local signal with the received signal data, and combining at least one of the local signals, received signal data, and the result of the correlation with the third phasor sequence, such that a signal received along the second direction is suppressed relative to a signal received along the first direction.

However, super-correlation or super-resolution techniques, for instance, as disclosed in patent application WO 2021/186194 A1, are very demanding in CPU (“Central Processing Unit”) and/or RAM (“Random Access Memory”) resources.

Therefore, the known solution presents drawbacks as indicated above, making it difficult to have accurate measurements in presence of multipath and/or spoofing attacks, especially in devices with reduced computational capabilities.

### BRIEF SUMMARY

In view of the above, embodiments of the present disclosure provide solutions which overcome one or more of the above drawbacks, providing GNSS receivers with increased detection capabilities of satellite signals replicas, for instance, replicas due to multipath and/or spoofing, calling for reduced computational capabilities.

One or more embodiments include a method for detecting satellite signal replicas. One or more embodiments include a related receiver apparatus and computer program product.

As mentioned before, the present disclosure relates to a method for detecting replicas of satellite signals in a GNSS receiver, such satellite signals transmitted from a plurality of satellites of a constellation of satellites, including in a navigation processing procedure performed at the GNSS receiver,
receiving at least one of such satellite signals, and
for such at least one of such received satellite signals:
   performing a GNSS tracking on such at least one of such received satellite signals, such tracking includes dumping in phase and quadrature components of a correlation procedure performed during the such GNSS tracking on such at least one of such received satellite signals, and
   receiving in a delay unit including a plurality of delay elements at the output of which are a plurality of correlation taps, such in phase and quadrature components, providing at each correlation tap of the plurality of correlation taps of the delay unit a delayed signal including such in phase and quadrature components, in particular such delay being the same for all the delay elements,
   performing a coherent accumulation over a given coherent accumulation period on each of such delayed signals obtaining a coherently accumulated signal,
   applying a transform to the frequency domain on such coherently accumulated signal obtaining a transformed signal which amplitude is representative of a correlation energy of such at least one of such received satellite signals,
   performing a non-coherent combination on such transformed signal to generate at least one bi-dimensional map, providing a distribution of such correlation energy of such at least one of such received satellite signals received at a given time and as a function of a code delay and a doppler frequency, and
   analysing such at least one bi-dimensional map to detect if the corresponding distribution of such correlation energy of such at least one of such received satellite signals is different from a bi-dimensional map of a signal not affected by replica signals, in order to determine if such at least one of such received satellite signals is affected by replicas, in particular if at least one anomalous feature indicative of presence of replica is detected in the energy distribution of such at least one of such received satellite signals provided in the at least one bi-dimensional map.

In variant embodiments, such analyzing includes performing a pattern recognition on such at least one bi-dimensional map classifying such at least one of such received satellite signals as affected by replicas or not on the basis of the pattern represented by such at least one bi-dimensional map, in particular if at least one anomaly is detected by classification in the energy distribution of such at least one of such received satellite signals provided in the at least one bi-dimensional map.

In variant embodiments, the at least one of such received satellite signals is further classified according to at least:
a line-of-sight energy peak value which is a maximum value of a line-of-sight component of such at least one of such received satellite, and/or
a line-of-sight energy peak code delay which is a code delay coordinate of the maximum value of the line-of-sight component of such at least one of such received satellite, and/or
a line-of-sight energy peak doppler frequency, which is a doppler frequency coordinate of the maximum value of the line-of-sight component of such at least one of such received satellite.

In variant embodiments, said pattern recognition is performed by a neural network analysing said at least one bi-dimensional map.

In variant embodiments, such classifying the at least one of such received satellite signals as affected by replicas is obtained by providing the at least one bi-dimensional map corresponding to the at least one of such received satellite signals to a neural network configured to detect anomalies resulting from the presence of replicas by analyzing such at least one bi-dimensional map.

In variant embodiments, such anomalies resulting from the presence of replicas in a bi-dimensional map are determined by at least:
a presence of a plurality of peaks in the correlation energy distribution of such bi-dimensional map, and/or
a presence of a secondary peak that is further than a given threshold from a line-of-sight energy peak value which is a maximum value of a line-of-sight component.

In variant embodiments, the neural network is a convolutional neural network.

In variant embodiments, a zero-padding is further appended to the coherently accumulated signal before the transformation to the frequency domain.

In variant embodiments, such coherently accumulated signal is further compensated for:
a receiver estimated clock drift value which compensates GNSS receiver clock drift errors, and/or
estimated receiver dynamics which compensate GNSS receiver errors resulting from GNSS receiver dynamics.

In variant embodiments, such transform to the frequency domain is done using a Fast Fourier Transform, or a Chirp Z-Transform, or a Fractional Fourier Transform, or a Fourier Transform.

In one embodiment, a method includes receiving a satellite signal at a GNSS receiver apparatus and generating in-phase and quadrature components from the satellite signal by performing a correlation procedure during GNSS tracking of the satellite signal. The method includes generating a respective delayed signal for each of a plurality of delay elements of the receiver apparatus. Each delay signal includes the in-phase and quadrature components, each delayed signal having a same delay. The method includes generating a coherently accumulated signal by performing a coherent accumulation on each of the delayed signals and obtaining a transformed signal by applying a transform to the frequency domain on the coherently accumulated signal. The method includes generating a bi-dimensional map providing a distribution of a correlation energy of the satellite signal based on a code delay and a doppler frequency of the transformed signal and determining whether the satellite signal is affected by replicas of the satellite signal based on the distribution of the correlation energy by analyzing the bi-dimensional map.

One embodiment includes a receiver apparatus configured to perform the steps of the method of any of the previous embodiments.

One or more embodiments include a computer program product directly loadable into the internal memory of a digital computer, including software code portions for performing the steps of the method of any of the previous embodiments.

Solutions as described herein facilitate obtaining GNSS receivers with increased detection capabilities of satellite signals replicas, for instance, replicas due to multipath and/or spoofing, calling for reduced computational capabilities and allowing possible improvement of accuracy and robustness of the position estimated by the GNSS receivers.

### BRIEF DESCRIPTION OF THE SEVERAL VIEWS OF THE DRAWINGS

Embodiments of the present disclosure will now be described with reference to the annexed drawings, which are provided purely by way of non-limiting example and in which:

FIG. 1 is a block diagram showing a GNSS (Global Navigation Satellite System) receiver;

FIG. 2 is an example of bi-dimensional map showing a correlation energy distribution of a satellite signal received by a GNSS receiver at a given time and as a function of both code delay and Doppler frequency, according to embodiments of the solution disclosed herein;

FIG. 3 is a block diagram showing a detector of satellite signal replicas, i.e., a multipath and/or spoofing detector, in a GNSS receiver according to embodiments of the solution disclosed herein; and

FIG. 4 is an example of classification algorithm, for instance, a convolutional neural network, used to analyse the bi-dimensional maps according to embodiments of the solution disclosed herein.

Corresponding numerals and symbols in the different figures generally refer to corresponding parts unless otherwise indicated.

The figures are drawn to clearly illustrate the relevant aspects of the embodiments and are not necessarily drawn to scale.

The edges of features drawn in the figures do not necessarily indicate the termination of the extent of the feature.

### DETAILED DESCRIPTION

In the ensuing description one or more specific details are illustrated, aimed at providing an in-depth understanding of examples of embodiments of this description. The embodiments may be obtained without one or more of the specific details, or with other methods, components, materials, etc. In other cases, known structures, materials, or operations are not illustrated or described in detail so that certain aspects of embodiments will not be obscured.

Reference to “an embodiment” or “one embodiment” in the framework of the present description is intended to indicate that a particular configuration, structure, or characteristic described in relation to the embodiment is included in at least one embodiment. Hence, phrases such as “in an embodiment” or “in one embodiment” that may be present in one or more points of the present description do not necessarily refer to one and the same embodiment.

Moreover, particular configurations, structures, or characteristics may be combined in any adequate way in one or more embodiments.

The headings/references used herein are provided merely for convenience and hence do not define the extent of protection or the scope of the embodiments.

For simplicity and ease of explanation, throughout this description, and unless the context indicates otherwise, like parts or elements are indicated in the various figures with like reference signs, and a corresponding description will not be repeated for each and every figure.

A navigation receiver operates by down converting to quasi-baseband the input signal received from the satellites, which is transmitted at L band (1-2 GHz), using a local oscillator to step down the input frequency and allow a baseband digital management of the satellite information.

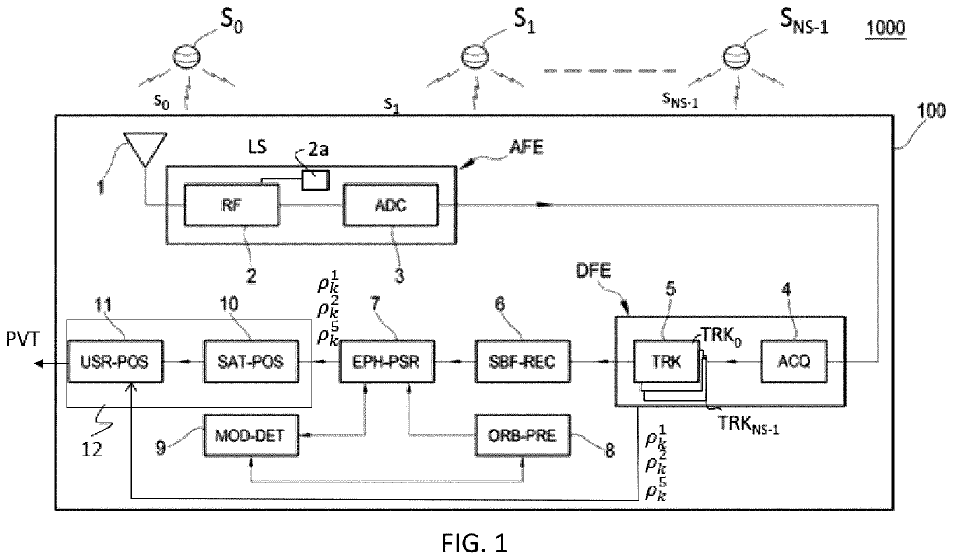

With reference to FIG. 1, which diagrammatically shows a GNSS (Global Navigation Satellite System) system 1000 (such as, for example, Global Positioning System (GPS), Global'naya Navigatsionnaya Sputnikovaya Sistema (GLONASS), Galileo System, or other types of satellite-based positioning systems, such global satellite positioning system 1000 includes a constellation of a number NS of satellites s₁-s_{NS} and at least a receiving apparatus 100. The satellite signals used in the GNSS (Global Navigation Satellite System) are of the CDMA-type (Code Division Multiple Access). The satellite signals reception at the receiving apparatus 100 is implemented through the following, sequentially performed, standard steps: analog filtering, frequency conversion and digitization, acquisition, tracking, decoding and positioning.

The receiving apparatus 100 includes an antenna 1, an analog receiving module AFE (Analog Front End), provided with a radiofrequency (RF) stage 2, and an analog-digital converter 3 (ADC), which can be implemented by hardware modules.

Further, the receiving apparatus 100 includes a digital processing module DFE (Digital Front End), including an acquisition module 4 (ACQ), and a tracking module 5 (TRK).

Moreover, the receiving apparatus 100 is provided with a sub-frame recovery module (SBF-REC) 6, an ephemerides processing and pseudo-range calculation module 7 (EPH-PSR), a satellites orbits prediction module 8 (ORB-PRE), a satellite type detecting module 9 (MOD-DET), a satellite position calculation module 10 (SAT-POS), and a user position calculation module 11 (USR-POS).

In various embodiments, acquisition module 4 and tracking module 5 can be implemented by hardware, while the remaining modules 6-11 can be implemented by software. In addition, it is observed that the acquisition module 4 and tracking module 5 can also be implemented by a hardware and software combination.

The receiving apparatus 100 is provided with a central processing unit, memories (mass memory and/or working storage) and respective interfaces (not shown in figures), including a microprocessor or microcontroller, for running the software resident in it.

The following embodiments are described in a non-limiting way referring to the GPS technology, however the teachings of the present disclosure can be applied also to other satellite positioning systems.

When the receiving apparatus 100 operates, the antenna 1 receives a plurality of signals s₀, . . . , s_{NS-1} from one or more satellites s₀-s_{NS-1} of the constellation of satellites operating in system 1000. For example, these signals can be modulated on a carrier having a frequency of about 1.5 GHz. Particularly, each received signal transports a pseudo-random code and a message for the data communication.

The pseudo-random code, by way of example a CA code, for example at 1 MHz, is used for distinguishing a satellite from another, and enables the receiving apparatus 100 to measure the time instant at which a signal has been transmitted by a corresponding satellite. Pseudo-random code is implemented by a sequence of pulses, called chips.

The radio frequency stage 2 operates on the signals received by antenna 1 (of the analog type) and converts them to the base band or to an intermediate frequency. Analog-digital converter 3 converts the intermediate frequency signals to corresponding digital signals. The radio-frequency stage 2 operates the conversion at an intermediate frequency using the frequency of a local signal LS which may be supplied by a Temperature Compensated Crystal Oscillator (TCXO) 2a.

The acquisition block 4 identifies in the digital signals originated by the analog-digital converter 3 the satellites in visibility, testing their presence by trying to match their transmitted PRN (Pseudo Random Noise) code sequence, i.e., the CA code, with a corresponding local replica and when a peak confirmation is found it provides the initial GNSS information, i.e., code/frequency information to an elementary Intermediate Frequency tracking correlation block. Further, the acquisition module 4 detects a plurality of parameters associated to the satellites and used for time tracking the satellite. In particular, the acquisition may test a local replica parametrized by a C/A code and over a grid of frequency bins. The actual received frequency may thus be different from nominal carrier due to the local oscillator error and to the relative motion of the user with respect to the satellite relative motion (resulting in the doppler shift).

The data navigation message transports data (for example at a bit rate equal to 50 Hz) and particularly is modulated based on the Binary Phase Shift Keying (BPSK) technique. Further, data navigation message is hierarchically divided in frames and sub-frames and transports several information, among them a plurality of parameters used for determining the orbit and consequently the position of satellites.

The tracking module 5 has a plurality tracking channels, indicated by a channel index k from 0 to NS−1, in particular indicated as TRK₀ . . . TRK_{NS-1} and each is allocated to a different satellite of the constellation. Specifically, the tracking module 5 is configured to operate as carrier tracking loop, which can be designed to follow either the phase of the incoming signal—using Phase Lock Loops (PLL), or the Doppler frequency of the incoming signal using Frequency Lock Loops (FLL). Phase noise, residual fluctuation of the tracking process, is intended as a quality metric and it is adopted to identify the goodness of the tracking itself at a given carrier to noise C/No.

The tracking module 5 is configured to supply data to the sub-frame recovery module 6, as a time sequence of samples pairs, indicated with {I, Q}. Each sample {I, Q} is for example the result of a coherent integration, respectively in-phase and quadrature, of a bit of 20 ms, performed by a correlator based on the modulation technique Binary Phase Shift Keying (BPSK), each samples pair {I, Q} represents a transmitted bit.

Moreover, for each satellite, in the tracking module 5 the Doppler frequency and the transfer time of the GPS signal transmitted by a satellite s₀-s_{N}S are determined.

Each k-th tracking channel TRKₖ includes thus, in a way known per se, a frequency locked loop and also a carrier to noise ratio meter, which estimates the carrier to noise ratio C/No, for instance every N (e.g., 10) accumulation periods of frequency loop of the tracking channel, where the elementary coherent one is bounded by the bit length of the signal being considered, e.g., of 20 ms for the GPS L1/CA case, and aligned to the 1^{st} millisecond of the bit.

The sub-frame recovery module 6, by means of suitable algorithms, decodes the different received sub-frames forming the navigation data message. In particular, the first elementary decoded unit may correspond to a so called “Word”, then many words build a subframe, many subframes a frame, many frames the whole navigation message. The ephemerides processing and pseudo-range calculation module 7 stores the satellite orbit, as ephemerides data.

In the embodiment of FIG. 1 it is shown that the tracking module 5 performs the calculation of the pseudo ranges, as the difference between time of transmission and time of arrival. Given a certain epoch at the receiver processing, the time of arrival is tagged by local received clock, the time of transmission is given by the tracking code loop. In FIG. 1 in particular are indicated three raw pseudo-ranges ρₖ¹, ρₖ², and ρₖ⁵ from a first, a second, and a third carrier signal respectively, in the example L1, L2, and L5 GPS carrier signal respectively, for the k^{th} satellite, supplied by module 5 to module 11. By these calculated values, and the time for transferring the GPS signal, the satellite position calculation module 10 calculates the positions of the satellites expressed by 3D coordinates, at the moment of transmission.

In embodiments, the satellite orbit prediction module 8 may be activated for assisting the ephemerides processing and pseudo-range calculation module 7 and/or satellite position calculation module 10 when the ephemerides data are not available at the receiving apparatus 100.

In embodiments, the satellite type detecting module 9 may be configured to determine the type of the tracked satellite and by it the solar radiation pressure model to be used in the orbit prediction by the satellite orbit prediction module 8. The satellite type detecting module 9 enables to determine the type of satellite in order to select the solar radiation pressure model which better provides for the shape, mass and size of a satellite.

In this embodiment, the satellite position calculation module 10 operates on the time for transferring the GPS signal together with the reception time (known due to a clock inside the receiving apparatus 100). The satellite position calculation module 10 receives from subframe parameters which describe an arc of satellite orbit. Then, given the current epoch, it selects the point of such arc on which the satellite is currently located, which is described in an XYZ cartesian reference frame, earth centered and earth fixed. Then for each satellite in view, on the basis of the pseudo-ranges assessed by the tracker 5, e.g., ρₖ¹, ρₖ² and ρₖ⁵, sent to the position calculation block 10, given the satellite position XYZ, assessed by the position calculation block 10 itself, such position calculation block, fitting the positions with all the satellites in view with the distance measured for each satellite, calculates the user position (ECEF XYZ) and user clock bias that better accommodate with received input data. This is used then to calculate subsequently the position velocity time PVT.

By a triangulation algorithm, the user position calculation module 11 calculates the position of the receiving apparatus 100 based on the distances of the receiving apparatus 100 preferably from at least four satellites and based on the positions of the same satellites, known at this processing stage. In the following, the position of the receiving apparatus 100 (practically coinciding with the user position) is be called “fix”.

Here modules 10 and 11 are indicated as belonging to a navigation processing module 12 which receiving such pseudo range measurements, previously calculated by such GNSS receiver, in particular by module 5, calculate the position velocity time PVT of the receiver. Such pseudo range measurements ρₖ¹, ρₖ² and ρₖ⁵ may pertain a first carrier signal, a second carrier signal, and a third carrier signal, in particular GPS L1, L2, and L5 respectively, but even a subset of these carriers may be considered, for instance, considering the carrier L1 leading to the pseudo range ρₖ¹ and the carrier L2 leading to the pseudo range ρₖ² when the carrier L5 is not available, or any other combination.

It is noted that the navigation processing operation may be in general defined in more general schematic as the operation following the tracking channels in module 5, and may include sometimes also the pseudo-range measurements calculation.

As mentioned, the tracking module 5 includes a plurality of channels, i.e., tracking correlation blocks which are usually let working in parallel each tuned on a different satellite PRN code and frequency, among the ones previously identified by the acquisition block 4, with the goal to confirm or eventually discard the acquisition hypothesis for every of them. For the confirmed satellites, after a startup refinement of the code and frequency initially provided by the acquisition block, the stable locked tracking phase starts. It consists into tightly following both the frequency offset (velocity) and the code phase (distance) of the satellite vehicle being analyzed and to demodulate the position and time information embedded in its bit stream. This information is then provided for instance to a Kalman Filter to triangulate the receiver position.

The tracking channel as mentioned includes a correlator which includes a PRN (pseudorandom noise) delayed sequence generator. The GNSS signals received at the receiver includes a ranging code modulated into the carrier, also called Pseudo-Random Noise (PRN) code, which spreads the spectrum and allows retrieving ranging information. Therefore, it is beneficial that the tracking channel include a PRN delayed sequence generator, which generates PRN sequences which are early, punctual or delayed one with respect to the other to perform correlation with the ranging codes.

The solution here described in brief refers to a method for detecting replicas of satellite signals in a GNSS receiver, such satellite signals transmitted from a plurality of satellites of a constellation of satellites, including in a navigation processing procedure performed at the GNSS receiver,
receiving at least one of such satellite signals, and
for such at least one of such received satellite signals:
   performing a GNSS tracking on such at least one of such received satellite signals, such tracking including dumping in phase and quadrature components of a correlation procedure performed during the such GNSS tracking on such at least one of such received satellite signals, and
   receiving in a delay unit including a plurality of delay elements at the output of which are a plurality of correlation taps, such in phase and quadrature components, providing at each correlation tap of the plurality of correlation taps of the delay unit a delayed signal including such in phase and quadrature components, in particular such delay being the same for all the delay elements,
   performing a coherent accumulation over a given coherent accumulation period on each of such delayed signals obtaining a coherently accumulated signal,
   applying a transform to the frequency domain on such coherently accumulated signal obtaining a transformed signal which amplitude is representative of a correlation energy of such at least one of such received satellite signals,
   performing a non-coherent combination on such transformed signal to generate at least one bi-dimensional map, providing a distribution of such correlation energy of such at least one of such received satellite signals received at a given time and as a function of a code delay and a doppler frequency, and
   analysing such at least one bi-dimensional map to detect if the corresponding distribution of such correlation energy of such at least one of such received satellite signals is different from a bi-dimensional map of a signal not affected by replica signals, in order to determine if such at least one of such received satellite signals is affected by replicas, in particular if at least one anomalous feature indicative of presence of replica is detected in the energy distribution of such at least one of such received satellite signals provided in the at least one bi-dimensional map.

Thus, differently from the known solutions that analyze the satellite signals in a code delay domain with the consequent disadvantage of estimating not sufficiently accurate or robust positions, the solution here described discloses a GNSS receiver structure that is able to detect replicas, for instance, that are generated by multipath and/or spoofing, through a joint analysis of one or more bi-dimensional maps considering both the code delay domain and a Doppler frequency domain.

The introduction of bi-dimensional maps considering both the code delay domain and the Doppler frequency domain may overcome the limitations of known solutions that are based on the detection of multipath/spoofing through a one-dimension analysis, i.e., in a code-delay domain. In fact, such one-dimension analysis is limited in resolution by a sampling frequency of a GNSS receiver and a number of correlators available on each tracking channel of the tracking module 5 of such GNSS receiver, resulting in mixed or non-conclusive outcomes since multipath/spoofing effects are difficult to separate from other impairments, for instance, from a noise affecting received signals or from receiver dynamics, when analyzed only in the code-delay domain.

In various embodiments of the solution disclosed herein, one or more of such bi-dimensional maps, also referred to as Delay-Doppler Maps, DDMs, are introduced for each satellite signal received in a plurality of satellite signals received. Each of such one or more bi-dimensional maps related to a given satellite signal received in such plurality of satellite signals received shows a correlation energy distribution of such given satellite signal received at a given time n and as a function of both a code delay CD and a Doppler frequency DF. Different bi-dimensional maps related to the same given satellite signal received differ for the time n in which they are collected.

In various embodiments, one or more bi-dimensional maps, namely Delay-Doppler Maps, DDMs, showing a correlation energy distribution of a given satellite signal received at a given time n as a function of both the code delay CD and the Doppler frequency DF are analyzed. Such Delay-Doppler Maps, DDMs may be pictures used to analyze signals, but may also be bi-dimensional data structures of any known type suitable to contain such correlation energy distribution as a function of both code delay CD and Doppler frequency DF such as, for instance, a matrix.

The analysis of such Delay-Doppler Maps, DDMs may be done through a neural network, for instance, a convolutional neural network or any other classification algorithm able to classify images or bi-dimensional data structures, or sequences of images, or sequences of bi-dimensional data structures, in order to classify a satellite signal received as affected by replicas, i.e., by multipath and/or spoofing interferences, if one or more anomalies are detected in the correlation energy distribution of such satellite signal received, i.e., in the respective bi-dimensional Delay-Doppler Map.

For each satellite signal received in such plurality of satellite signals received such analysis may be done considering one by one the Delay-Doppler Maps DDMs related to the selected satellite signal, for instance, considering only one Delay-Doppler Map DDM, or may be done considering the time evolution of the situation corresponding to such selected satellite signal received by analyzing a sequence of Delay-Doppler Maps DDMs obtained in different time instant n.

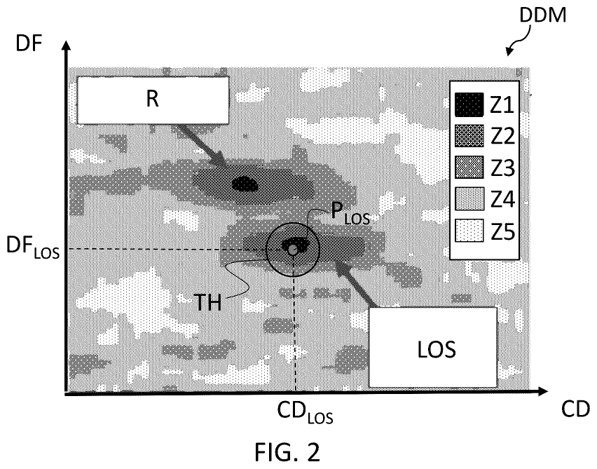

FIG. 2 is an example of bi-dimensional map DDM showing a correlation energy distribution of a selected satellite signal received by a GNSS receiver 100 at a given time n as a function of both code delay CD and Doppler frequency DF, according to embodiments of the solution disclosed herein.

As previously described, the analysis of a selected satellite signals is extended in two dimensions to facilitate the detection of anomalies in the correlation energy distribution DDM of such selected satellite signal, for instance, facilitating the detection of multiple peaks, for instance, R and LOS of FIG. 2, and/or splits of such multiple peaks.

FIG. 2 illustrates the correlation energy distribution DDM of a selected satellite signal at a specific time n and as a function of both code delay CD, represented on the x-axis of the diagram of FIG. 2, and Doppler frequency DF, represented on the y-axis of the diagram of FIG. 2. The correlation energy is represented by different hashing levels in FIG. 2, substantially with a decreasing intensity of gray hashing from a correlation energy value Z1 (the highest) to correlation energy Z5 (the lowest), as better indicated in the legend shown in the inset in FIG. 2.

In an optimal situation, i.e., without interferences due to multipath and/or spoofing and/or any other source, the correlation energy distribution DDM of a selected satellite signal presents a single peak P_{LOS}, at a code delay CD_{LOS} and a doppler frequency DF_{LOS}, i.e., the P_{LOS} peak code delay and doppler frequency coordinates, that corresponds to a Line-Of-Sight, LOS component of the selected satellite signal being received by the GNSS receiver, i.e., a component travelling in a direct path from the satellite to the GNSS receiver, without being affected by diffractions, refractions, reflections, absorptions, obstructions, or other types of alterations.

However, in a real environment satellite signals are usually affected by such alterations, i.e., by diffractions, refractions, reflections, absorptions, obstructions, or other types of alterations, especially in urban environments wherein the reflecting surfaces and obstacles are more frequently present.

In fact, in real environments a GNSS receiver usually receives, in addition to a selected satellite signal, i.e., a Line-Of-Sight, LOS component, replicas of such selected satellite signal that may be generated by different sources and that interfere with the selected satellite signal, thus, affecting the accuracy, reliability, and/or robustness of the position estimated by such GNSS receiver.

Replicas of such selected satellite signal may be generated in different ways, for instance, by the environment wherein the GNSS receiver is located as in the case of multipath, or by malicious users that transmits willingly a replica of a target satellite signal as in the case of spoofing, or through any other possible alteration of the satellite signal.

Such replicas of a selected satellite signal may differ from the Line-Of-Sight, LOS component of such selected satellite signal in power, code delay, carrier phase, and/or frequency, all of which interfere with the LOS component of the selected satellite signal and distort the correlation curve between the received selected satellite signal and the receiver replica corresponding to such selected satellite signal generated within the acquisition block 4, resulting in pseudo-range errors of various meters and in a consequent inaccurate, unreliable, and/or non-robust estimated position.

In a situation where the LOS component of a satellite signal is affected by interferences, for instance, due to multipath and/or spoofing and/or any other source, the correlation energy distribution DDM of such satellite signal may present multiple peaks, one of them P_{LOS} corresponding to the Line-Of-Sight, LOS component of the satellite signal being received by the GNSS receiver, while the others, for instance, the peak indicated as R in FIG. 2, that may be in any number, being distortions of the correlation energy distribution DDM due to such interferences.

In case of interferences affecting the LOS component of a selected satellite signal, the corresponding correlation energy distribution DDM is distorted and the resulting bi-dimensional map DDM may be considered as affected by anomalies. For instance, a first anomaly may be the presence of multiple peaks in the correlation energy distribution of a bi-dimensional map DDM, for instance, R and P_{LOS} in FIG. 2, and/or a second anomaly may be the presence of a secondary peak, for instance, the peak R of FIG. 2, that is far, for instance, further than a given threshold TH, from the line-of-sight energy peak value P_{LOS}, or any other anomaly that may differentiate a bi-dimensional map DDM from those obtained in optimal situations, i.e., situations in which there are no replica signals.

To summarize, exemplary anomalies resulting from the presence of replicas in a bi-dimensional map DDM, Z_{h,k}(n), i.e., a bi-dimensional map of a signal affected by multipath, spoofing, or any other similar interference, are determined by at least:
a presence of a plurality of peaks in the correlation energy distribution of such bi-dimensional map DDM, Z_{h,k}(n), and/or
a presence of a secondary peak R that is further than a given threshold TH from a line-of-sight energy peak value P_{LOS} which is a maximum value of a line-of-sight component.

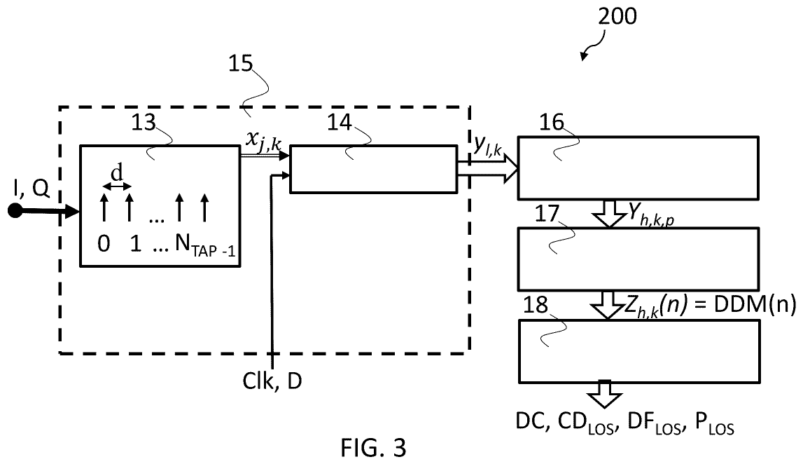

FIG. 3 is a block diagram showing a detector 200 able to detect replicas of a satellite signal received, for instance, a multipath and/or spoofing detector, in a GNSS receiver 100 according to embodiments of the solution disclosed herein.

Note that the following description is done considering a given satellite signal received in the plurality of satellite signals received by the GNSS receiver at a given time n, but such operations are performed on each of the satellite signals received in the plurality of satellite signals received by the GNSS receiver at the same given time n to detect replicas, for instance, due to multipath and/or spoofing, for a plurality of satellite signals received by the GNSS receiver.

Note that the same operations may be performed on each of the satellite signals received in the plurality of satellite signals received by the GNSS receiver for a different time n to detect replicas, for instance, due to multipath and/or spoofing, for a plurality of satellite signals received by the GNSS receiver at different times, for instance, to analyze the evolution of the behavior of the replicas related to each of the satellite signals received in time.

The multipath and/or spoofing detector 200 is configured to receive from the tracking module 5 the time sequence of samples pairs corresponding to the values I and Q, i.e., the in-phase and quadrature components, corresponding to a given satellite signal received in the plurality of satellite signal received.

Such time sequence of pairs of in-phase I and quadrature Q components is provided to an accumulation-delay unit 15 and, more in particular, to a delay sub-unit 13.

The delay sub-unit 13 is configured to receive the time sequence of pairs of in-phase I and quadrature Q components and to delay, for instance, of a uniform spacing d, for instance, 1 ms, such pairs, for instance, by applying a comb filtering on them.

In various embodiments, to delay such pairs I, Q, the delay sub-unit 13 includes a plurality of delay elements at the output of which are coupled a plurality of correlation taps, for instance, in a number equal to N_{TAP}, with respective indexes in the range 0-N_{TAP-1}.

Each of such delay elements is configured to receive a respective pair of in-phase I and quadrature Q components and to delay, for instance, of a given amount of delay d equal for all the delay elements, a complex signal xⱼ including such in phase I and quadrature Q components, wherein xⱼ=Iⱼ+iQⱼ, with j being a time-domain index representing a time in which the in-phase I and quadrature Q components have been obtained.

As a result of the delaying operation in the delay sub-unit 13 a delayed signal x_{j,k} including such in phase I and quadrature Q components is obtained, wherein x_{j,k}=I_{j,k}+iQ_{j,k}, with k being a delay tap index ranging from 0, for instance, the index of a first delay tap, to N_{TAP-1}, for instance, the index of a last of the delay taps.

In various embodiments, the delayed signals x_{j,k} may be obtained as:

$${x}_{j , k} = {\int }_{0}^{T} s ( {t}_{0} + jT + t ) * r ( {t}_{0} + jT + kS + t ) dt = {I}_{j , k} + {iQ}_{j , k}$$

with T being a dump period of the in phase I and quadrature Q components, for instance, 1 ms, s(t) being a transmitted GNSS satellite signal, t₀ being a start time of aligned signal reception, r(t) being the PRN receiver replica generated within the acquisition block 4, and S being a uniform tap spacing d in time units, for instance, 1 ms.

The delay sub-unit 13 is further configured to provide one or more of such delayed signals x_{j,k}, for instance, a delayed signal x_{j,k} for each delay element x_{j,0}, . . . , x_{j,N}_{_{TAP-1}}, to a coherent accumulation sub-unit 14, still included in the accumulation-delay unit 15.

The coherent accumulation sub-unit 14 is configured to receive one or more of such delayed signals x_{j,k} and to perform on each of such delayed signals x_{j,k} a coherent accumulation over a given coherent accumulation period N_{c} to obtain a coherently accumulated signal y_{l,k}, for instance, by using the following equation:

$${y}_{l , k} = {\sum }_{m = 0}^{{N}_{c} - 1} x ( l * {N}_{c} + m , k )$$

with l being a time-domain index representing a time in which the coherently accumulated signal y_{l,k} has been computed, and N_{c} being a coherent accumulation period.

In various embodiments, a zero-padding may be appended to the coherently accumulated signals y_{l,k}, obtaining:

$${y}_{l , k} = {\sum }_{m = 0}^{{N}_{c} - 1} x ( l * {N}_{c} + m , k ) for l \leq {N}_{cs}$$

$${y}_{l , k} = 0 for l > {N}_{cs}$$

with N_{cs} being a number of coherent samples utilized for performing a transformation to a frequency domain, for instance, a FFT (“Fast Fourier Transform”).

The coherently accumulated signals y_{l,k}, with or without appended zero-padding, may be used both to increase the frequency resolution of the available samples and to prepare such samples for being transformed to the frequency domain.

In various embodiments, the coherent accumulation sub-unit 14 may be configured to receive additional inputs, for instance, a receiver estimated clock drift value Clk and/or estimated receiver dynamics D, that may be used for compensating the coherently accumulated signals y_{l,k} for respective errors, i.e., errors due to a clock drift and GNSS receiver dynamics, for instance, a vehicle dynamic behavior wherein the GNSS receiver is installed, respectively.

The coherent accumulation sub-unit 14 is further configured to provide the coherently accumulated signals y_{l,k} as output of the accumulation-delay unit 15 and to a frequency domain transform unit 16.

In various embodiments, the coherent accumulation sub-unit 14 is further configured to provide to the frequency domain transform unit 16 an additional Ready signal indicating when the coherent accumulation of the delayed signals x_{j,k} is ended.

The frequency domain transform unit 16 is configured to receive the coherently accumulated signals y_{l,k} and to perform a transformation of such coherently accumulated signals y_{l,k} to a frequency domain, for instance, using a FFT (“Fast Fourier Transform”), a CZT (“Chirp Z-Transform”), a FRFT (“Fractional Fourier Transform”), a FT (“Fourier Transform”), or any other transformation to the frequency domain.

The results of such transformation to the frequency domain are transformed signals y_{h,k,p}, whose amplitude is representative of a correlation energy of the selected signal received in the plurality of satellite signals received.

In various embodiments, the Fast Fourier Transform FFT may be considered to transform the coherently accumulated signals y_{l,k} to the frequency domain, thus, the transformed signals y_{h,k,p} are obtained as:

$${Y}_{h , k , p} = {\sum }_{l = 0}^{{N}_{FFT} - 1} {y}_{n + p * {N}_{s} , k} * {e}^{- i \frac{2 π}{{N}_{FFT}} lh}$$

with h being a frequency-domain index, p being a time-domain index representing a time in which the transformed signals y_{h,k,p} have been computed, N_{FFT} being the size of the Fast Fourier Transform FFT with, for instance, N_{FFT}≥N_{cs}, n being a time-domain index representing a time in which a corresponding bi-dimensional map DDM have been obtained.

The frequency domain transform unit 16 is further configured to provide the transformed signals y_{h,k,p} to a non-coherent combinatory unit 17.

The non-coherent combinatory unit 17 is configured to receive the transformed signals y_{h,k,p} and to perform a non-coherent combination on such transformed signals y_{h,k,p} to generate a bi-dimensional map DDM, Z_{h,k}(n) corresponding to the correlation energy distribution of the respective selected satellite signal received at a given time n and as a function of both code delay CD and Doppler frequency DF.

In various embodiments, the bi-dimensional map DDM, Z_{h,k}(n) corresponding to a correlation energy distribution of a respective satellite signal received at time n may be obtained as:

$${Z}_{h , k} ( n ) = {\sum }_{p = 0}^{{N}_{i} - 1} ‖ {Y}_{h , k , p} ‖$$

with Nᵢ being a number of non-coherent accumulations.

The non-coherent combinatory unit 17 is further configured to provide the bi-dimensional map DDM, Z_{h,k}(n) to a classification algorithm 18, for instance, a neural network.

Such classification algorithm 18, for instance, a neural network, is configured to detect and/or classify anomalies in the correlation energy distribution of a respective satellite signal received at such time n by considering the respective bi-dimensional map DDM, Z_{h,k}(n).

Specifically, such classification algorithm 18 may be configured to detect multipath and/or spoofing, and/or, in various embodiments, to estimate a line-of-sight LOS energy peak value P_{LOS}, i.e., the LOS peak value of the energy distribution, and/or a line-of-sight LOS energy peak delay CD_{LOS}, i.e., the code delay CD corresponding to the LOS peak value, and/or doppler frequency DF_{LOS}, i.e., the doppler frequency DF corresponding to the LOS peak value (reference to FIG. 2).

Thus, in general it is provided, analysing such at least one bi-dimensional map DDM, Z_{h,k}(n) to detect if the corresponding distribution of such correlation energy of such at least one of the received satellite signals is different from a bi-dimensional map of a signal not affected by replica signals, in order to determine if such at least one of such received satellite signals is affected by replicas. This detection can be performed in different ways, e.g., finding the relative maxima of the distribution energy, e.g., by any maximum detection algorithm, and if there are more than one above a given threshold, this may correspond to detect the first anomaly indicated above, i.e., the presence of multiple peaks in the correlation energy distribution of a bi-dimensional map DDM, for instance, R and P_{LOS} in FIG. 2. Also, given the relative maxima, the distance between such maxima can be computed to detect the second anomaly mentioned above, i.e., presence of a secondary peak, for instance, the peak R of FIG. 2, that is far, for instance, further than a given threshold TH, from the line-of-sight energy peak value P_{LOS}, or any other geometrical feature that may differentiate a bi-dimensional map DDM from those obtained in optimal situations, i.e., situations in which there are no replica signals. Thus, such analysing the at least one bi-dimensional map DDM, Z_{h,k}(n) may determine that the at least one of such received satellite signals is affected by replicas, in particular if at least one anomalous feature, e.g., first anomaly and/or second anomaly indicated above, indicative of presence of replica is detected in the energy distribution of such at least one of such received satellite signals provided in the at least one bi-dimensional map DDM, Z_{h,k}(n)).

Then, in embodiments, such analysis can be performed by performing a pattern recognition on the at least one bi-dimensional map DDM, Z_{h,k}(n), specifically, the classification algorithm 18 may be configured to classify a bi-dimensional map DDM, Z_{h,k}(n), i.e., to classify a respective satellite signal received at a specific time n according to its correlation energy distribution retrievable in such respective bi-dimensional map DDM, Z_{h,k}(n), as affected by replicas, for instance, due to multipath and/or spoofing, if the pattern of the bi-dimensional map DDM, Z_{h,k}(n) is classified as anomalous with differences from a bi-dimensional map of a signal not affected by replica signals, as for instance the classifier is trained to classify as anomalous maps containing one of the first or second anomalies described with reference to FIG. 2 in the correlation energy distribution related to such respective satellite signal received and provided in the corresponding analysed bi-dimensional map DDM. Of course, the classifier could be also trained on the basis of maps from signals with or without replicas, indicating which are good (no replicas) and which are not good (replicas), without necessarily have the classifier to classify according to the presence of such first anomaly and/or second anomaly and/or any other anomaly which indicates presence of replicas, by spoofing or multipath.

To summarize, such analysis may include performing a pattern recognition, for instance, using a classifier, a neural network, or any other pattern recognition algorithm, on such at least one bi-dimensional map DDM, Z_{h,k}(n) classifying 18 such at least one of such received satellite signals as affected by replicas, i.e., by multipath, spoofing, or any other similar interference, or not on the basis of the pattern represented by such at least one bi-dimensional map DDM, Z_{h,k}(n), in particular if at least one anomaly, i.e., the presence of a secondary peak, for instance, the peak R of FIG. 2, that is far, for instance, further than a given threshold TH, from the line-of-sight energy peak value P_{LOS}, or any other geometrical feature that may differentiate a bi-dimensional map DDM from those obtained in optimal situations, i.e., situations in which there are no replica signals, is detected by classification in the energy distribution of such at least one of such received satellite signals provided in the at least one bi-dimensional map DDM, Z_{h,k}(n).

In various embodiments, the classification 18 of the at least one of such received satellite signals as affected by replicas is obtained by providing the at least one bi-dimensional map DDM, Z_{h,k}(n) corresponding to the at least one of such received satellite signals to a neural network 18, for instance, previously trained on the basis of maps from signals with or without replicas, indicating which are good (no replicas) and which are not good (replicas), configured to detect anomalies resulting from the presence of replicas by analysing such at least one bi-dimensional map DDM, Z_{h,k}(n), i.e., without necessarily have the classifier to classify according to the presence of such first anomaly and/or second anomaly and/or any other anomaly which indicates presence of replicas, by spoofing or multipath.

In various embodiments, the neural network 18 may be a convolutional neural network, CNN.

In various embodiments, the classification algorithm 18 may be configured to analyze a time sequence of bi-dimensional maps DDM(n), Z_{h,k}(n) to decide if a time-varying scenario is affected by multipath and/or spoofing. The number of elements in such time sequence of bi-dimensional maps DDM(n), Z_{h,k}(n) may be any number.

In various embodiments, the classification algorithm 18 is further configured to provide the results of the detection and/or classification DC to a positioning engine and/or tracking channels to allow estimating an accurate, robust, and reliable PVT (“Position, Velocity and Time”) solution.

In various embodiments, also the line-of-sight LOS energy peak value P_{LOS}, the line-of-sight LOS energy peak delay CD_{LOS}, and the line-of-sight LOS energy peak doppler frequency DF_{LOS} are provided to such positioning engine and/or tracking channels.

To summarize, at least one of such received satellite signals may be further classified 18 according to at least:
a line-of-sight energy peak value P_{LOS} which is a maximum value of a line-of-sight component of such at least one of such received satellite, and/or
a line-of-sight energy peak code delay CD_{LOS} which is a code delay coordinate of the maximum value of the line-of-sight component of such at least one of such received satellite, and/or
a line-of-sight energy peak doppler frequency DF_{LOS}, which is a doppler frequency coordinate of the maximum value of the line-of-sight component of such at least one of such received satellite.

In addition, the further classification 18 of the at least one of such received satellite signals done according to the line-of-sight energy peak value P_{LOS} and/or the line-of-sight energy peak delay CD_{LOS} and/or the line-of-sight energy peak doppler frequency DF_{LOS}, is obtained by providing the at least one bi-dimensional map DDM, Z_{h,k}(n). corresponding to the at least one of such received satellite signals to a pattern recognition algorithm 18, for instance, to a classifier, a neural network, or any other pattern recognition algorithm, configured to detect the line-of-sight energy peak value P_{LOS} and/or the line-of-sight energy peak delay CD_{LOS} and/or the line-of-sight energy peak doppler frequency DF_{LOS} by analysing such at least one bi-dimensional map DDM, Z_{h,k}(n).

Note that embodiments of the solution disclosed herein may be obtained also with a software implementation on classic GNSS receiver hardware, for instance, partially sacrificing efficiency, still reaching higher accuracy, robustness, and reliability with respect to the known solutions.

To summarize, the method disclosed herein is a method for detecting replicas of satellite signals, for instance, due to multipath, spoofing or any other source, in a GNSS receiver 100, such satellite signals s₀, . . . , s_{NS-1} transmitted from a plurality of satellites s₀, . . . , s_{NS-1} of a constellation of satellites 1000, for instance, GPS, GLONASS, Galileo, etc., including in a navigation processing procedure performed at the GNSS receiver 100,
receiving at least one of such satellite signals s₀, . . . , s_{NS-1}, for instance, at any carrier frequency, for instance, L1, L2 or L5 for GPS signals, and
for such at least one of such received satellite signals s₀, . . . , s_{NS-1}:
performing a GNSS tracking 5 on such at least one of such received satellite signals s₀, . . . , s_{NS-1}, such tracking including dumping in phase I and quadrature Q components of a correlation procedure performed during the such GNSS tracking 5 on such at least one of such received satellite signals, and
receiving in a delay unit 13, for instance, a comb filtering unit, including a plurality of delay elements at the output of which are a plurality of correlation taps 0-N_{TAP-1}, such in phase I and quadrature Q components, providing at each correlation tap of the plurality of correlation taps 0-N_{TAP-1} of the delay unit 13 a delayed signal x_{j,k} including such in phase I and quadrature Q components, in particular such delay being the same d for all the delay elements, i.e., the elements are uniformly spaced,
performing a coherent accumulation 14 over a given coherent accumulation period N_{c} on each of such delayed signals x_{j,k} obtaining a coherently accumulated signal y_{l,k},
applying a transform to the frequency domain 16, for instance, a FFT (“Fast Fourier Transform”), a CZT (“Chirp Z-Transform”), a FRFT (“Fractional Fourier Transform”), a FT (“Fourier Transform”), or any other transformation to the frequency domain, on such coherently accumulated signal y_{l,k} obtaining a transformed signal y_{h,k,p} which amplitude is representative of a correlation energy of such at least one of such received satellite signals s₀, . . . , s_{NS-1},
performing a non-coherent combination 17 on such transformed signal y_{h,k,p} to generate at least one bi-dimensional map DDM, Z_{h,k}(n), providing a distribution of such correlation energy of such at least one of such received satellite signals received at a given time n and as a function of a code delay CD and a doppler frequency DF, and
analysing such at least one bi-dimensional map DDM, Z_{h,k}(n) to detect if the corresponding distribution of such correlation energy of such at least one of such received satellite signals is different from a bi-dimensional map of a signal not affected by replica signals, i.e., a signal in a scenario not involving multipath, spoofing, or any other similar interference, in order to determine if such at least one of such received satellite signals is affected by replicas, in particular if at least one anomalous feature indicative of presence of replica, for instance, the presence of multiple peaks, an high distance between peaks, or any other geometrical difference that may be found between a map of a signal affected by replicas and a map of a signal in an optimal condition, i.e., not affected by replicas, is detected in the energy distribution of such at least one of such received satellite signals provided in the at least one bi-dimensional map DDM, Z_{h,k}(n).

In various embodiments, a zero-padding may be further appended to the coherently accumulated signal y_{l,k} before the transformation to the frequency domain 16.

In various embodiments, such coherently accumulated signal y_{l,k} may be further compensated for:
a receiver estimated clock drift value Clk which compensates GNSS receiver clock drift errors, and/or
estimated receiver dynamics D which compensate GNSS receiver errors resulting from GNSS receiver dynamics.

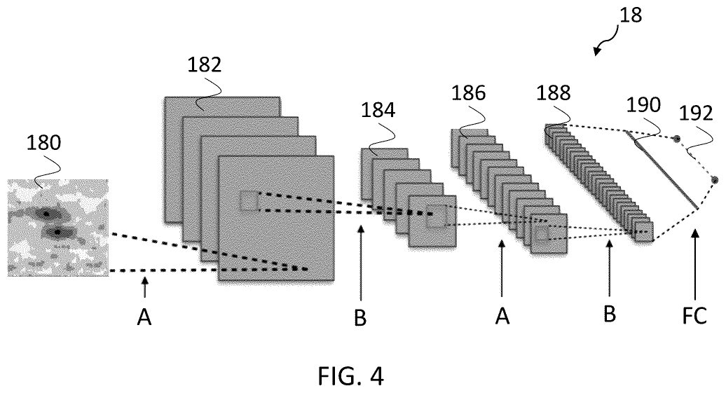

FIG. 4 is an example of classification algorithm 18, for instance, a neural network, and, more precisely, a convolutional neural network CNN, 18 used to analyse the bi-dimensional maps DDM, 180 according to embodiments of the solution disclosed herein.

As previously described, any classification algorithm 18 able to analyze and classify images or bi-dimensional data structures may be considered for the solution disclosed herein. Therefore, the following example of a neural network and, more in particular, of a convolutional neural network CNN, should not be considered as limiting the scope of protection of the present application.

An example of a classification algorithm 18 may be a convolutional neural network CNN with the structure illustrated in FIG. 4.

For instance, a bi-dimensional map DDM, 180 may be provided as input to such convolutional neural network CNN, 18 that may include a plurality of hidden layers, for instance:
a first convolutional hidden layer 182 obtained by performing a convolution operation A on such bi-dimensional map DDM, 180,
a second pooling hidden layer 184 obtained by performing a subsampling operation B on the first convolutional hidden layer 182,
a third convolutional hidden layer 186 obtained by performing a convolution operation A on such second pooling hidden layer 184,
a fourth pooling hidden layer 188 obtained by performing a subsampling operation B on the third convolutional hidden layer 186, and
a fully connected layer FC, 190 operating on the fourth pooling hidden layer 188.

Such convolutional neural network CNN, 18 includes also an output layer 192 coupled to the fully connected layer FC, 190, and configured to detect multipath and/or spoofing, and/or, in various embodiments, to estimate a line-of-sight LOS energy peak value P_{LOS}, i.e., the LOS peak value of the energy distribution, and/or a line-of-sight LOS energy peak delay CD_{LOS}, i.e., the code delay CD corresponding to the LOS peak value, and/or doppler frequency DF_{LOS}, i.e., the doppler frequency DF corresponding to the LOS peak value.

For instance, in various embodiments, the output layer 192 may include two nodes, a first node indicating that the satellite signal corresponding to the bi-dimensional map DDM, 180 provided as input is not affected by replicas, and therefore the PVT solution evaluated starting from it may be considered accurate and reliable, and a second node indicating that the satellite signal corresponding to the bi-dimensional map DDM, 180 provided as input is affected by replicas, and therefore the PVT solution may be evaluated, for instance, after a correction of the satellite signal received.

The use of a neural network, for instance, a convolutional neural network CNN, for instance, for image analysis, may facilitate a simple detection of anomalous patterns in a bi-dimensional map DDM, 180 under analysis.

In fact, neural networks are able to detect anomalous patterns in an autonomous way, without calling for the GNSS receiver designer to set any threshold or other parameter to be used for anomalies detection, for instance, there is no call for a designer to set a threshold TH indicating the maximum allowable distance between the LOS peak P_{LOS} and the replicas peaks, for instance, the peak R.

Thus, using a neural network in such detection operation results in a more precise and reliable detection as it can learn complex non-linear relationships in the bi-dimensional map DDM, 180 provided as input.

Such neural network, for instance, the convolutional neural network, may be trained using actual ranges obtained from an accurate positioning device to automatically label a training set. The training set may be augmented to improve and increase available data in the training set, for instance, by applying one or more among operations of flipping, rotating, cropping, zooming, translating, injecting noise, etc., to the original bi-dimensional maps DDMs. The algorithm may be trained using unsupervised training and techniques for detecting anomalies.

Solutions as described herein facilitate obtaining a GNSS receiver including:
a delay unit configured to receive from a tacking module in phase and quadrature components related to a selected satellite signal received in a plurality of satellite signals received, and to delay a signal including such in phase and quadrature components obtaining a plurality of delayed signals,
a coherent accumulation unit configured to perform a coherent accumulation on each of such delayed signals obtaining a coherently accumulated signal,
a frequency domain transform unit configured to transform such coherently accumulated signal to the frequency domain, obtaining a transformed signal which amplitude is representative of a correlation energy that is related to such selected satellite signal received in the plurality of satellite signals received, and
a non-coherent combinatory unit configured to perform a non-coherent combination on such transformed signal to generate a bi-dimensional map representing a distribution of such correlation energy of the respective selected satellite signal received at a given time and as a function of a delay and a doppler frequency,
and wherein a classification algorithm is configured to classify the selected satellite signal received as affected by replicas if at least one anomaly is detected in the energy distribution related to such selected satellite signal received and provided in the analysed bi-dimensional map.

Thus, solutions as described herein facilitate obtaining GNSS receivers with increased detection capabilities of satellite signals replicas, for instance, replicas due to multipath and/or spoofing and/or any other source, calling for reduced computational capabilities and allowing possible improvement of accuracy, robustness, and reliability of the position estimated by the GNSS receivers.

Without prejudice to the underlying principles, the details and the embodiments may vary, even significantly, with respect to what has been described by way of example only without departing from the scope of the embodiments.

The extent of protection is determined by the annexed claims.

A method for detecting replicas of satellite signals in a GNSS receiver (100), said satellite signals (s₀, . . . , s_{NS-1}) transmitted from a plurality of satellites (s₀, . . . , s_{NS-1}) of a constellation of satellites (1000), including in a navigation processing procedure performed at the GNSS receiver (100), receiving at least one of said satellite signals (s₀, . . . , s_{NS-1}), and for said at least one of said received satellite signals (s₀, . . . , s_{NS-1}): performing a GNSS tracking (5) on said at least one of said received satellite signals (s₀, . . . , s_{NS-1}), said tracking including dumping in phase (I) and quadrature (Q) components of a correlation procedure performed during the said GNSS tracking (5) on said at least one of said received satellite signals, and receiving in a delay unit (13) including a plurality of delay elements at the output of which are a plurality of correlation taps (0-N_{TAP-1}), said in phase (I) and quadrature (Q) components, providing at each correlation tap of the plurality of correlation taps (0-N_{TAP-1}) of the delay unit (13) a delayed signal (x_{j,k}) including said in phase (I) and quadrature (Q) components, in particular said delay being the same (d) for all the delay elements, performing a coherent accumulation (14) over a given coherent accumulation period (N_{c}) on each of such delayed signals (x_{j,k}) obtaining a coherently accumulated signal (y_{l,k}), applying a transform to the frequency domain (16) on said coherently accumulated signal (y_{l,k}) obtaining a transformed signal (y_{h,k,p}) which amplitude is representative of a correlation energy of said at least one of said received satellite signals (s₀, . . . , s_{NS-1}), performing a non-coherent combination (17) on said transformed signal (y_{h,k,p}) to generate at least one bi-dimensional map (DDM, Z_{h,k}(n)), providing a distribution of said correlation energy of said at least one of said received satellite signals received at a given time (n) and as a function of a code delay (CD) and a doppler frequency (DF), and analysing said at least one bi-dimensional map (DDM, Z_{h,k}(n)) to detect if the corresponding distribution of said correlation energy of said at least one of said received satellite signals is different from a bi-dimensional map of a signal not affected by replica signals, in order to determine if said at least one of said received satellite signals is affected by replicas, in particular if at least one anomalous feature indicative of presence of replica is detected in the energy distribution of said at least one of said received satellite signals provided in the at least one bi-dimensional map (DDM, Z_{h,k}(n)).

Said analysing may include performing a pattern recognition on said at least one bi-dimensional map (DDM, Z_{h,k}(n)) classifying (18) said at least one of said received satellite signals as affected by replicas or not on the basis of the pattern represented by said at least one bi-dimensional map (DDM, Z_{h,k}(n)), in particular if at least one anomaly is detected by classification in the energy distribution of said at least one of said received satellite signals provided in the at least one bi-dimensional map (DDM, Z_{h,k}(n)).

The at least one of said received satellite signals may be further classified (18) according to at least: a line-of-sight energy peak value (P_{LOS}) which is a maximum value of a line-of-sight component of said at least one of said received satellite, and/or a line-of-sight energy peak code delay (CD_{LOS}) which is a code delay coordinate of the maximum value of the line-of-sight component of said at least one of said received satellite, and/or a line-of-sight energy peak doppler frequency (DF_{LOS}), which is a doppler frequency coordinate of the maximum value of the line-of-sight component of said at least one of said received satellite.

Said pattern recognition (18) may be performed by a neural network (18) analysing said at least one bi-dimensional map (DDM, Z_{h,k}(n)).

Said classifying (18) the at least one of said received satellite signals as affected by replicas may be obtained by providing the at least one bi-dimensional map (DDM, Z_{h,k}(n)) corresponding to the at least one of said received satellite signals to a neural network (18) configured to detect anomalies resulting from the presence of replicas by analyzing said at least one bi-dimensional map (DDM, Z_{h,k}(n)).

Said anomalies resulting from the presence of replicas in a bi-dimensional map (DDM, Z_{h,k}(n)) may be determined by at least: a presence of a plurality of peaks in the correlation energy distribution of said bi-dimensional map (DDM, Z_{h,k}(n)), and/or a presence of a secondary peak (R) that is further than a given threshold (TH) from a line-of-sight energy peak value (P_{LOS}) which is a maximum value of a line-of-sight component.

The neural network (18) may be a convolutional neural network (CNN).

A zero-padding may be further appended to the coherently accumulated signal (y_{l,k}) before the transformation to the frequency domain (16).

Said coherently accumulated signal (y_{l,k}) may be further compensated for: a receiver estimated clock drift value (Clk) which compensates GNSS receiver clock drift errors, and/or estimated receiver dynamics (D) which compensate GNSS receiver errors resulting from GNSS receiver dynamics.

Said transform to the frequency domain (16) may be done using a Fast Fourier Transform, or a Chirp Z-Transform, or a Fractional Fourier Transform, or a Fourier Transform.

A GNSS receiver apparatus may be configured to perform the method.

Computer program product directly loadable into the internal memory of a digital computer, including software code portions for performing the steps of the method.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method, comprising, in a navigation processing procedure performed at the GNSS receiver:
receiving at least one satellite signal of a plurality of satellite signals transmitted from a plurality of satellites; and
for the at least one satellite signal:
performing a GNSS tracking on the at least one satellite signal, including dumping in-phase and quadrature components of a correlation procedure performed during the GNSS tracking on the at least one satellite signal;
receiving in a delay unit including a plurality of delay elements at the output of which are a plurality of correlation taps, the in-phase and quadrature components, providing at each correlation tap of the plurality of correlation taps of the delay unit a delayed signal including the in-phase and quadrature components, the delay being the same for all the delay elements;
obtaining a coherently accumulated signal by performing a coherent accumulation over a given coherent accumulation period on each of such delayed signals;
obtaining a transformed signal having an amplitude that is representative of a correlation energy of the at least one satellite signal by applying a transform to the frequency domain on the coherently accumulated signal;
performing a non-coherent combination on the transformed signal to generate at least one bi-dimensional map, providing a distribution of the correlation energy of the at least one satellite signal received at a given time and as a function of a code delay and a doppler frequency; and
analysing the at least one bi-dimensional map to detect if the corresponding distribution of the correlation energy of the at least one of the received satellite signals is different from a bi-dimensional map of a signal not affected by replica signals in order to determine if the at least one satellite signal is affected by replicas by detecting if at least one anomalous feature indicative of presence of replica is in the energy distribution of the at least one of satellite signal provided in the at least one bi-dimensional map.

2. The method according to claim 1, wherein the analysing includes performing a pattern recognition on the at least one bi-dimensional map classifying the at least one satellite signal as affected by replicas or not on the basis of the pattern represented by the at least one bi-dimensional map if at least one anomaly is detected by classification in the energy distribution of the at least one satellite signal provided in the at least one bi-dimensional map.

3. The method according to claim 2, wherein the at least one satellite signal is further classified according to at least:
a line-of-sight energy peak value which is a maximum value of a line-of-sight component of the at least one of the received satellite; or
a line-of-sight energy peak code delay which is a code delay coordinate of the maximum value of the line-of-sight component of the at least one satellite signal; or
a line-of-sight energy peak doppler frequency, which is a doppler frequency coordinate of the maximum value of the line-of-sight component of the at least one satellite signal.

4. The method according to claim 2, wherein the pattern recognition is performed by a neural network analysing the at least one bi-dimensional map.

5. The method according to claim 2, wherein the classifying the at least one of satellite signal as affected by replicas is obtained by providing the at least one bi-dimensional map corresponding to the at least one of the received satellite signals to a neural network configured to detect anomalies resulting from the presence of replicas by analyzing the at least one bi-dimensional map.

6. The method according to claim 5, wherein the anomalies resulting from the presence of replicas in a bi-dimensional map are determined by at least:
a presence of a plurality of peaks in the correlation energy distribution of the bi-dimensional map; or
a presence of a secondary peak that is further than a given threshold from a line-of-sight energy peak value which is a maximum value of a line-of-sight component.

7. The method according to claim 4, wherein the neural network is a convolutional neural network.

8. The method according to claim 1, wherein a zero-padding is further appended to the coherently accumulated signal before the transformation to the frequency domain.

9. The method according to claim 1, comprising compensating the coherently accumulated signal for:
a receiver estimated clock drift value which compensates GNSS receiver clock drift errors; or
estimated receiver dynamics which compensate GNSS receiver errors resulting from GNSS receiver dynamics.

10. The method according to claim 1, wherein the transform to the frequency domain is done using a Fast Fourier Transform, or a Chirp Z-Transform, or a Fractional Fourier Transform, or a Fourier Transform.

11. A GNSS receiver apparatus, comprising:
one or more memories storing software instructions:
one or more processors configured to execute the software and to perform a process based on the execution of the software instructions, the process including:
receive at least one satellite signal of a plurality of satellite signals transmitted from a plurality of satellites; and
for the at least one satellite signal:
performing a GNSS tracking on the at least one satellite signal, including dumping in-phase and quadrature components of a correlation procedure performed during the GNSS tracking on the at least one satellite signal;
receiving in a delay unit including a plurality of delay elements at the output of which are a plurality of correlation taps, the in-phase and quadrature components, providing at each correlation tap of the plurality of correlation taps of the delay unit a delayed signal including the in-phase and quadrature components, the delay being the same for all the delay elements;
obtaining a coherently accumulated signal by performing a coherent accumulation over a given coherent accumulation period on each of such delayed signals;
obtaining a transformed signal having an amplitude that is representative of a correlation energy of the at least one satellite signal by applying a transform to the frequency domain on the coherently accumulated signal;
performing a non-coherent combination on the transformed signal to generate at least one bi-dimensional map, providing a distribution of the correlation energy of the at least one satellite signal received at a given time and as a function of a code delay and a doppler frequency; and
analysing the at least one bi-dimensional map to detect if the corresponding distribution of the correlation energy of the at least one of the received satellite signals is different from a bi-dimensional map of a signal not affected by replica signals in order to determine if the at least one satellite signal is affected by replicas by detecting if at least one anomalous feature indicative of presence of replica is in the energy distribution of the at least one of satellite signal provided in the at least one bi-dimensional map.

12. The GNSS receiver apparatus according to claim 11, wherein the analysing includes performing a pattern recognition on the at least one bi-dimensional map classifying the at least one satellite signal as affected by replicas or not on the basis of the pattern represented by the at least one bi-dimensional map if at least one anomaly is detected by classification in the energy distribution of the at least one satellite signal provided in the at least one bi-dimensional map.

13. The GNSS receiver apparatus according to claim 12, wherein the at least one satellite signal is further classified according to at least:
a line-of-sight energy peak value which is a maximum value of a line-of-sight component of the at least one of the received satellite signal; or
a line-of-sight energy peak code delay which is a code delay coordinate of the maximum value of the line-of-sight component of the at least one satellite signal; or
a line-of-sight energy peak doppler frequency, which is a doppler frequency coordinate of the maximum value of the line-of-sight component of the at least one satellite signal.

14. The GNSS receiver apparatus according to claim 12, wherein the pattern recognition is performed by a neural network analysing the at least one bi-dimensional map.

15. The GNSS receiver apparatus according to claim 12, wherein classifying the at least one of satellite signal as affected by replicas is obtained by providing the at least one bi-dimensional map corresponding to the at least one satellite signal to a neural network configured to detect anomalies resulting from the presence of replicas by analyzing the at least one bi-dimensional map.

16. A method, comprising:
receiving a satellite signal at a GNSS receiver apparatus;
generating in-phase and quadrature components from the satellite signal by performing a correlation procedure during GNSS tracking of the satellite signal;
generating a respective delayed signal for each of a plurality of delay elements of the receiver apparatus, each delay signal including the in-phase and quadrature components, each delayed signal having a same delay;
generating a coherently accumulated signal by performing a coherent accumulation on each of the delayed signals;
obtaining a transformed signal by applying a transform to the frequency domain on the coherently accumulated signal;
generating a bi-dimensional map providing a distribution of a correlation energy of the satellite signal based on a code delay and a doppler frequency of the transformed signal; and
determining whether the satellite signal is affected by replicas of the satellite signal based on the distribution of the correlation energy by analyzing the bi-dimensional map.

17. The method of claim 16, wherein determining whether the satellite signal is affected by replicas includes detecting an anomalous feature in the distribution of the correlation energy.

18. The method of claim 16, comprising appending a zero-padding to the coherently accumulated signal before transformation to the frequency domain.

19. The method of claim 16, comprising compensating the coherently accumulated signal for a receiver estimated clock drift value.

20. The method of claim 16, comprising compensating the coherently accumulated signal for estimated receiver dynamics.
